(19) United States
(12) Patent Application Publication
(10) Pub. No.: US 2021/0019689 A1
(43) Pub. Date: Jan. 21, 2021

(54) SYSTEM AND METHOD FOR ALLOCATING CREATIVE WORKFLOW RESOURCES

(71) Applicant: NBCUNIVERSAL MEDIA, LLC, Universal City, CA (US)

(72) Inventors: Steven Sneddon, Maplewood, NJ (US); Chris Zembower, Brooklyn, NY (US); Kevin Fornito, Ridgewood, NY (US); Zach Madell, New York, NY (US)

(73) Assignee: NBCUNIVERSAL MEDIA, LLC, Universal City, CA (US)

(21) Appl. No.: 16/926,577

(22) Filed: Jul. 10, 2020

Related U.S. Application Data
(60) Provisional application No. 62/876,571, filed on Jul. 19, 2019.

(51) Int. Cl. G06Q 10/06; G06F 9/451

(52) U.S. Cl. CPC G06Q 10/063118; G06F 9/452

(57) ABSTRACT

Systems and methods for providing a cloud-based environment for creating media content are disclosed. According to at least one embodiment, a method for providing a cloud-based environment for creating media content includes: requesting, from a user, information regarding the cloud-based environment to be provided; and receiving, from the user, the information. The information includes at least a number of graphic artists to be served by the cloud-based environment or a number of editors to be served by the cloud-based environment. The method further includes creating the cloud-based environment based on the information. Creating the cloud-based environment includes creating a particular number of instances of virtual desktops in a cloud data center, wherein the particular number is based on the information.

### CROSS-REFERENCE TO RELATED APPLICATIONS

Pursuant to 35 U.S.C. § 119(e), this application claims the benefit of U.S. Provisional Patent Application Ser. No. 62/876,571, filed on Jul. 19, 2019, the contents of which are hereby incorporated by reference herein in their entirety.

### BACKGROUND

High-performance computing workstations may be used in the production of media content (e.g., graphic art, editorial content, television programs for either broadcast or other forms of distribution, etc.). Such workstations are used by individuals including media artists and video editors. While using such workstations to perform tasks relating to the production of media content, these individuals may value features relating to system performance, responsiveness, speed, render times, color and/or lag times.

However, the costs associated with providing such workstations may be quite high. These costs include not only the costs associated with purchasing hardware, but also costs associated with maintaining the workstations over time.

### SUMMARY

With respect to various embodiments disclosed herein, techniques are described for reducing costs of and increasing the ease and efficiency for dynamically providing high-performance computing workstations used in the production of media content. For example, according to at least one embodiment, a cloud-based infrastructure model is used to create (e.g., autonomously create) and provide a production environment to facilitate production of media content. The creation of the production environment may be based on specific needs that have been indicated. Accordingly, various embodiments are directed to providing users with an automated service delivery.

According to at least one embodiment, a method for providing an environment for creating media content is disclosed. The method includes: requesting, from a user, information regarding the environment to be provided; and receiving, from the user, the information. The information includes at least a number of graphic artists to be served by the environment or a number of editors to be served by the environment. The method further includes creating the environment based on the information. Creating the environment includes creating a particular number of instances of virtual desktops in a cloud data center, wherein the particular number is based on the information.

### BRIEF DESCRIPTION OF THE DRAWINGS

The above and other aspects and features of the present disclosure will become more apparent upon consideration of the following description of embodiments, taken in conjunction with the accompanying drawing figures.

FIG. 1 is a block diagram illustrating providing of a production environment according to least one embodiment.

FIG. 2 is a block diagram illustrating creating of a production environment according to least one embodiment.

### DETAILED DESCRIPTION

In the following detailed description, reference is made to the accompanying drawing figures which form a part hereof, and which show by way of illustration specific embodiments of the present invention. It is to be understood by those of ordinary skill in this technological field that other embodiments may be utilized, and that structural, as well as procedural, changes may be made without departing from the scope of the present invention. Wherever possible, the same reference numbers will be used throughout the drawings to refer to the same or similar parts.

Computing infrastructure (e.g., workstations) that is typically used to facilitate production of media content may be associated with various disadvantages and/or drawbacks. For example, acquiring such infrastructure may require relatively high capital costs. By way of example, a single workstation (e.g., a single high-performance workstation) may cost approximately $10,000 in hardware costs alone. Further, the workstation may need to be replaced based on a particular refresh cycle (e.g., a three-year refresh cycle). The ordering, wiring, installation and configuration of such hardware consumes time, which may be considered as a cost of an additional type.

With continued use, the workstation may also require significant resources relating to maintenance. For example, hardware failures require a certain amount of down time to diagnose issues and perform repairs, which involve tasks such as troubleshooting of software, replacement of hardware, etc. Such tasks are typically performed by technical professionals having specialized training.

Over time, the hardware that is implemented in the workstation may eventually limit the software that can be run or executed using the hardware. For example, over the course of a particular refresh cycle, it is possible that the hardware that is in use becomes incapable of efficiently running newer software or newer software versions (e.g., the most recent Adobe Creative Cloud software/features).

As another example, memory storage costs may be quite high. Media creation typically requires (or at least benefits from) interfacing with high-performance storage media (e.g., servers, etc.). Such storage devices are typically quite expensive and may require frequent upgrades to keep up with storage demands. Also, such storage devices may also need to be replaced based on a particular refresh cycle (e.g., a three-to-five-year refresh cycle).

In addition to the costs that have been described, portability may present additional disadvantages and/or drawbacks. For example, a location at which a particular workstation is installed, may need to be pre-wired with fiber cabling. As another example, to use the workstation, a user (e.g., an artist, an editor) is generally required to be physically present at the installation location. In many situations, the user is unable to use the workstation while physically located at some other location (e.g., a home office, a different office location, etc.).

Aspects of the present disclosure are directed to addressing one or more of the noted disadvantages and/or drawbacks. According to one or more aspects, a cloud-based infrastructure model is used. By way of example, the cloud-based infrastructure model may use Virtual Desktop Infrastructure (VDI) technology. For example, workstation simulators may be provided to users such as artists and editors. The workstation simulators are configured to connect to cloud-based virtual desktops. Accordingly, a user may use the virtual desktop via the workstation simulator, to perform tasks associated with media creation.

In at least some embodiments, the VDI technology handle technical/processing specification requirements for handling media production workflows. Such specification requirements may relate to GPU (graphics processing unit) utilization, frame rate, color representation, etc. According to one or more aspects, GPU-enabled cloud-based virtual machines, dynamically scalable high-performance cloud-native storage and/or infrastructure-as-code methodologies are utilized to facilitate full end-to-end media production workflows.

According to aspects of the present disclosure, backend systems (including directory service (e.g., Active Directory), connection broker, shared user storage, etc.) and/or artist/editor desktops are hosted in the cloud. Artist/editor desktops may be created on demand with a particular systems image (e.g., a latest Windows image). Additionally, the created desktops may be non-persistent. In this regard, the desktops may be readily “destroyed” when not in use. The “destroyed” desktops may be recreated at a later time when needed again.

User data (desktop, documents, etc.) may reside on shared user storage. Folder redirection allows an artist or editor to access his/her personal data from any of various machines (e.g., workstation simulators). As such, an artist or editor who works remotely may utilize a VPN (Virtual Private Network) to access his/her workstation(s) in a secure manner. For example, a remote artist working from a home office can connect to his/her workstation(s) via the Internet.

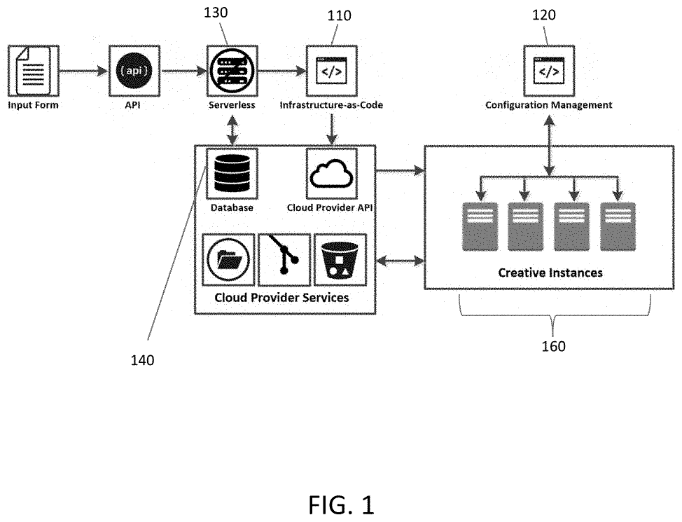

According to aspects of the present disclosure, various cloud-based technologies and/or methodologies may be employed. With reference to FIG. 1, these technologies/methodologies include: infrastructure-as-code 110; configuration management 120; serverless functions 130; and database(s) 140.

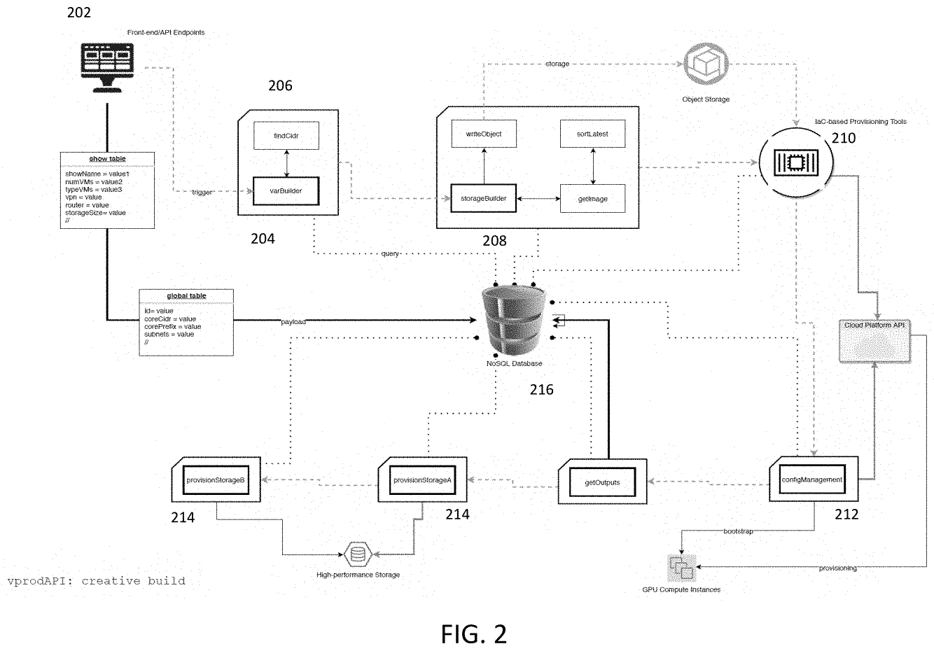

Infrastructure-as-code (IaC) 110 refers to a process in which data centers are provisioned and managed via scripts and/or declarative definitions, rather than manual processes or tools. Infrastructure-as-code 110 prioritizes factors including automation, efficiency, versioning and reusability. According to various embodiments, infrastructure-as-code 110 is utilized to automate and/or orchestrate a providing of a production environment, as will be described in more detail later with further reference to FIG. 2.

Configuration management 120 refers to a process of automating deployment and configuration of settings and software for both physical machines and virtual machines (e.g., virtual desktops). Configuration management 120 may be used to concurrently deploy software or configurations to multiple systems. Configuration management 120 may be aligned and/or used in conjunction with infrastructure-as-code 110.

A process for providing a production environment according to at least one embodiment will now be described with reference to FIG. 2.

A request for information (e.g., a front-end webform) is presented at a front-end endpoint 202. The front-end endpoint may be a desktop or mobile computing device connected to the Internet. Information that is requested via the front-end webform may include a name of a show or program (to be created using the production environment that is to be provided), a type of compute instances (e.g., artist workstation, editor workstation) that is to be created, a corresponding number of compute instances, required storage size, and/or whether a VPN is needed.

Information provided in response to the request is received. For example, the information is received from the front-end endpoint 202. It is understood that the response may specify multiple types of compute instances (e.g., both artist workstations and editor workstation) and, correspondingly, the number of compute instances for each type.

The information that is provided is input to one or more serverless functions (e.g., serverless functions 130 of FIG. 1). With reference to FIG. 2, the serverless functions may include varBuilder 204, findCidr 206, storageBuilder 208, IaC-based provisioning tools 210, configManagement 212 and/or provisionStorage 214. The one or more serverless functions may output information to a database (e.g., database 140 of FIG. 1). With reference to FIG. 2, the serverless functions may output information to a centralized cloud database 216.

The function varBuilder 204 uses the provided information to configure downstream processes. The function findCidr 206 discovers available network ranges and allocates the discovered network ranges for the new production environment. The function storageBuilder 208 uses cloud provisioner templates to build high-availability storage clusters. The IaC-based provisioning tools 210 provision cloud-based computing resources by utilizing a particular systems image (e.g., a latest Windows image) and triggering a Cloud Platform API (application programming interface) 218. The function configManagement 212—is then used to complete the provisioning of the endpoints (e.g., by installing software, registering systems with Directory Services, setting Group Policy, Folder Redirection, etc.) The function provisionStorage 214 controls configuration of high-performance storage for use by users such as artists and editors.

By way of example—according to at least one embodiment, a request for information is provided via a web-based form. The web form may be configured such that it can be completed by a non-technical user. For example, the web form may be configured to request information that is not overly technical—e.g., a number of graphic artists (e.g., Photoshop artists, After Effects artists) and a number of editors that will be working to create the media content. The web form may also be configured to request information regarding an amount of high-performance memory storage that is desired and/or required. The web form may also be configured to request the name of the show/program on which the artists and editors will be working.

A response is received from the user. For example, the response may provide the information noted in the previous paragraph—e.g., a particular number of graphic artists and a particular number of editors that will be working to create the media content, the amount of high-performance memory storage that is desired and/or required, the name of the show/program on which the artists and editors will be working.

The receipt of the response triggers an autonomous providing of a production environment to facilitate production of the show/program. For example, the production environment may include backend infrastructure, virtual networks, storage devices and/or VDI desktops that are suitable for facilitating production of the show/program based on the information provided by the user. In this regard, the number of VDI desktops (e.g., VDI workstations) that are created may be based on the number of graphic artists and the number of editors that were indicated. For example, the number of VDI desktops that are created may equal a particular value retrieved from a look-up table, where the particular value corresponds to the number of graphic artists and the number of editors that were indicated. As a further example, the particular value may reflect a number of VDI desktops that is estimated to be needed by the indicated numbers of personnel (e.g., graphic artists and editors).

Based on the response from the user, instances of workstations are created to reside in a cloud data center. The number of instances is commensurate with the determined number of workstations.

In another example, users may not explicitly specify the number of users expected to participate in the production. The user may instead provide other information regarding production that will require the system to more intelligently determine the type and amount of resources to allocate. In one aspect, this information may include the type of media content to be created such as whether it will be a television show, a live action film, an animated film, a live sporting event, a live news event, a show meant for distribution over the Internet. Because different types of media content may require different resources, by specifying the type of media content to be created, the system may select a subset of the type of resources to allocate. In another aspect, the information may include the schedule corresponding to different milestones for creating the media content. The schedule may indicate when production is to begin and end, when post-production is to begin and end, when the show expects to be available for distribution, when the show will air, etc. By providing the schedule, the system will be able to more accurately allocate resources because if the schedule is compressed, the system may assume more people will work on the show to meet the tighter deadlines and thereby allocate more resources. That said, a show with long deadlines with many milestones may still require many people but a show with long deadlines but with a fewer number of milestones may have less priority and fewer personnel and therefore need fewer resources. In other aspects, the quality of the content may also affect the number and type of resources to be allocated. For example, shows intended for display in standard definition, high definition, 4K, 8K, and other resolutions may require different types and amounts of resources. In another aspect, if the media content is to be created in many different geographical locations, the resource allocation may also consider allocating cloud resources in different geographies and in greater consecutive time blocks because more people can be working on a project over consecutive periods of time when they are in different time zones. Further, while the foregoing disclosure has described an instance of a virtual desktop as a resource, other examples of resources are also applicable. For example, for a single virtual desktop, there may be multiple time blocks for which the desktop is allocated to a production or to a user and each one of those time blocks may be a separate resource or a group of resources. When a production involves teams from different geographies and therefore different time zones, it may be an efficient use of resources to allow the same production to use a virtual desktop for a longer period (e.g., 6 PM-6 AM Pacific) because users in Asia, for example, may be able to utilize time slots that are not normally utilized during the evening and night hours of the Pacific time zone. Further, as production demands and timelines change over time, the system may adapt to user input to support sudden increases or decreases in resources as well and the scheduling of those resources may be determined based on the techniques previously described.

A particular capacity of high-performance storage residing in the cloud data center is also reserved. The storage capacity may also be commensurate with the number of instances. For example, the storage reserved may be at least sufficient to allow the workstation instances to communicate with each other and to exchange files and other data between one another.

According to at least one embodiment, a new isolated cloud environment is created on demand with network rules to communicate with Cloud Provider Services. Artist and editor workstations may be created on demand using the latest Windows Images. Once booted, configuration management may install the software necessary for artists and/or editors to perform their tasks.

Upon completion of the automated process, the user may be presented with a dashboard providing detailed information about the newly provisioned infrastructure. For example, the dashboard may be provided at the front-end endpoint 202. The user may then be able to view/edit resources on demand. For example, the user may view IP addresses and hostnames, edit system specs, etc. The user may also add additional users (or groups of users), set access policies, and view/edit high-performance storage configuration.

As described earlier, the production environment may be provided to facilitate creation of a show (or program). Once creation of the show is completed, the resources of the production environment may no longer be needed. For such a situation, the user is afforded the ability to “collapse” the production environment at least temporarily. The “collapsing” of the environment may not involve an irreversible destruction of the production environment. Rather, a snapshot of the production environment (including all data that was created and any preferences that were defined) may be performed, and the snapshot may be archived in cloud-based storage. If needed at a later time, the production environment corresponding to the show may be “rehydrated.” The data that had been created is retrieved from the archived storage, and restored to the high-performance storage of the production environment. In addition, compute resources (e.g., virtual workstations) may be recreated on demand.

As described earlier, one or more aspects of this disclosure are directed to using a cloud-based infrastructure model to provide a production environment for producing media content. The production environment is provided (e.g., customized) based on the needs of a user for creating a particular show (or program). According to at least one embodiment, the production environment is provided in an automated (or autonomous) manner, such that the providing of the environment may be considered as an automated delivery of a service for the benefit of the user.

According to one or more embodiments, ease of management may be improved. For example, the use of non-persistent desktops (e.g., VDI desktops) allow administrators to maintain one master image, instead of managing individual desktops for each user. As another example, a degree of scalability may be improved. In this regard, a cloud architecture may be scaled dynamically based on the number of users that are needed and/or working at a given time. This may serve to eliminate (or at least reduce) over-provisioning. Further, this allows administrators to add/remove resources as necessary, thereby improving cost effectiveness. Under the public cloud model, customers typically pay only for the resources (e.g., computing resources, storage resources, etc.) that are reserved and/or used.

Similar to the adding of resources, the upgrading of resources may be accomplished more readily. For example, under the public cloud model, hardware specifications that are set forth may be scaled up on demand as necessary. Similarly, software specifications may be upgraded/modified on demand. For example, when needed, a newest version of software (e.g., Adobe Creative Cloud) may be applied to the master image and deployed to workstations.

According to one or more embodiments, a degree of reliability may be improved. For example, utilizing a public cloud enables hosting workstations in different geographic availability zones. This may improve disaster resiliency and may improve accessibility regardless of the geographical location(s) at which one or more users are located. For example, because workstations are hosted in the cloud, a user may virtually access hosted workstations from any of various geographical locations (e.g., geographical locations at which a suitably secure connection can be provided). As such, it may be possible for an artist/editor to work remotely (e.g., from a home office).

According to one or more embodiments, a degree of security/protection (e.g., from hackers) may be improved. As described earlier, data associated with a show/program resides not at endpoints (e.g., a physical workstation installed at a geographic location accessible by a user) but in a cloud environment (e.g., high-performance storage in the cloud). Protecting the cloud environment may be more feasible than protecting individual endpoints. In this regard, the provided infrastructure may use machine images on which recent security patches (e.g., the most recent security patches) have been installed.

The foregoing described embodiments and features are merely exemplary and are not to be construed as limiting the present invention. The present teachings can be readily applied to other types of apparatuses and processes. The description of such embodiments is intended to be illustrative, and not to limit the scope of the claims. Many alternatives, modifications, and variations will be apparent to those skilled in the art.

What is claimed is:

1. A method for providing a cloud-based infrastructure model for providing a cloud-based environment for creating media content, the method comprising:
requesting, from a user, information regarding the cloud-based environment to be provided;
receiving, from the user, the information; and
creating the cloud-based environment based on the information,
wherein creating the cloud-based environment comprises:
generating a particular number of instances of virtual desktops in a cloud data center,
wherein the particular number is based on the information.

2. The method of claim 1, wherein the information comprises a number of graphic artists to be served by the environment or a number of editors to be served by the cloud-based environment, and wherein the request is presented at a front-end endpoint such as a desktop or a mobile computing device connected to a network.

3. The method of claim 1, wherein the information comprises at least one of a type of media content to be created, a schedule corresponding to milestones for the creation of the media content, a quality of the media content, a type of computing instance, a number of computing instances, or one or more geographic locations corresponding to where the media content is to be produced, wherein the one or more geographic locations enables the allocation of resources in consecutive time blocks.

4. The method of claim 3, wherein the schedule comprises an expected production start date, an expected production end date, an expected post production start date, or an expected post production end date, or any combination thereof.

5. The method of claim 3, wherein creating the cloud-based environment comprises:
determining a type of computing resources required based on the type of media content to be created (e.g., live action, animation, etc.) and/or the quality of the media content (e.g., standard definition, high definition, 4K, 8K, etc.);
determining an amount of the determined type of computing resources required based on the schedule corresponding to milestones for the creation of the media content and a number of content creators for each type of content creator associated with the media content production, geographic locations corresponding to where the media content is to be produced.

6. The method of claim 5, generating the particular number of instances is based on the determined amount of the determined type of computing resources.

7. The method of claim 1, wherein creating the cloud-based environment further comprises:
reserving high-performance memory storage, for facilitating exchange of data between the virtual desktops.

8. The method of claim 1, wherein the information regards creation of a media program or show.

9. The method of claim 1, wherein the cloud-based environment is created autonomously based on the information.

10. The method of claim 1, wherein each of the virtual desktops comprises at least one of a non-persistent virtual desktop or a Virtual Desktop Infrastructure (VDI) workstation.

11. The method of claim 1, wherein each of the virtual desktops is operable by an operator located at a remote location.

12. The method of claim 1, wherein creating the cloud-based environment is performed using at least one of infrastructure-as-code (IaC) in which data center are provisioned and managed via scripts and/or declarative definitions to automate and/or orchestrate a providing of a production environment, a configuration management for automating deployment and configuration of settings and software for both physical machines and virtual machines such as virtual desktops, a serverless function or a database.

13. The method of claim 1, wherein the information comprises an amount of memory storage that is desired or required.

14. The method of claim 1, wherein the cloud-based environment is created to include at least one of backend infrastructure, virtual networks, storage devices or Virtual Desktop Infrastructure (VDI) desktops that are suitable for facilitating production of the media content, based on the information.

15. The method of claim 1, further comprising allocating, to the user, at least one of the particular number of instances of virtual desktops for one or more particular time blocks.

16. The method of claim 1, further comprising controlling a display to display a dashboard providing information regarding the created cloud-based environment.

17. The method of claim 1, further comprising receiving, from the user, a request to collapse the created cloud-based environment.

18. The method of claim 17, further comprising, in response to receiving the request to collapse the created cloud-based environment, performing a snapshot of the created cloud-based environment, to facilitate a later rehydration of the created cloud-based environment.

19. An apparatus comprising any feature and/or component described, either individually or in combination with any feature or component, in any configuration, and configured to perform the functions described.

20. A machine-readable non-transitory medium having stored thereon machine-executable instructions for providing a cloud-based infrastructure model for providing a cloud-based environment for creating media content, the instructions comprising:
requesting, from a user, information regarding the cloud-based environment to be provided;
receiving, from the user, the information; and
creating the cloud-based environment based on the information,
wherein creating the cloud-based environment comprises:
generating a particular number of instances of virtual desktops in a cloud data center,
wherein the particular number is based on the information.
